(19) United States
(12) Patent Application Publication
(10) Pub. No.: US 2024/0375962 A1
(43) Pub. Date: Nov. 14, 2024

(54) Method and System for Treating CO2

(71) Applicant: D-CRBN BV, Antwerp (BE)

(72) Inventors: Gill SCHELTJENS, Wilrijk (BE); Georgi TRENCHEV, Antwerp (BE); David ZIEGLER, Antwerp (BE)

(21) Appl. No.: 18/692,071

(22) PCT Filed: Sep. 20, 2022
(86) PCT No.: PCT/EP2022/076110

§ 371 Date: Mar. 14, 2024

(30) Foreign Application Priority Data
Sep. 20, 2021 (EP) 21197851.5

(51) Int. Cl. C01B 32/40; C21B 5/00; C21B 5/06

(52) U.S. Cl. CPC C01B 32/40; C21B 5/001; C21B 5/06; C21B 2005/005; C21B 2100/22; C21B 2100/282

(57) ABSTRACT

The present invention concerns a method for producing carbon monoxide (CO), comprising the steps of: providing a gaseous initial input stream comprising carbon dioxide (CO2) to a plasma zone: at least partially converting said CO2 to CO by: (a) igniting a plasma in the plasma zone: (b) extracting an output stream from the plasma zone, said output stream comprising less CO2 than said first stream, and recycling said output stream as a gaseous input stream to said plasma zone and further converting CO2 to CO by performing steps (a) and (b), thereby obtaining a final output stream comprising more CO and less CO2 than the initial input stream.

### TECHNICAL FIELD

The present invention concerns a method and system for treating carbon dioxide (CO2) exhausted by CO2 producing installations, preferably blast furnaces, thereby recovering carbon monoxide (CO). The present invention is particularly applicable to CO-consuming methods and systems, such as iron extraction methods and systems.

### BACKGROUND

Blast furnaces are the main tool of metallurgy. They operate on the principle of chemical reduction, where metal ores are reduced to their main metal components by reacting with gases or other solids at high temperature. The most common reduction reaction is the reduction of iron ore, typically in the form of ferric oxide (Fe₂O₃) with CO to iron (Fe) and CO2:

Fe₂O₃+3 CO→2 Fe+3 CO₂

As can be seen from the reaction, for every ton of iron (Fe), approx. 1.2 tons of CO2 are produced. Indeed, nearly 7% of the global CO2 emissions emerge from steel production. In the light of the efforts for CO2 emissions reduction, the present invention aims to provide a means to reduce, and even eliminate, the CO2 emission footprint of the steel industry.

In fact, the present invention aims to reduce CO2 emissions of applications which consume CO. Hereto, the present invention particularly aims to provide a method and system for recovering CO from CO2, such as is produced in blast furnaces to produce iron from iron ore.

A prior art method for producing CO from CO2 is disclosed in U.S. Pat. No. 4,190,636A. This document discloses an improved method of producing carbon monoxide in a plasma arc reactor, wherein carbon dioxide is delivered to an arc to form a plasma into which solid carbon is delivered. The products are quenched and filtered to yield carbon monoxide.

### SUMMARY OF THE INVENTION

The present invention relates to a novel plasma-based system as a solution to reduce CO2 emission, in particular the CO2 emission footprint of the steel industry. Thereto, the present invention relates to a method and a system for producing carbon monoxide (CO) as disclosed in claims 1, 2 and 5. The invention also concerns an iron production method and an iron production system as disclosed in claims 6 and 7. Further embodiments of the invention are disclosed in the dependent claims and further in this document.

Low-temperature plasmas are known for their chemical reactivity. An atmospheric discharge in CO2 gas will produce the following reaction:

CO2→CO+O ΔH=283 kJ/mol

Hence, it seems that a plasma reactor is a viable method for CO recovery from CO2 emissions. Practically, the CO2 emissions can be:
captured from the CO2-comprising exhaust gasses of an installation, e.g. a blast furnace,
reduced to CO in a plasma reactor, and
re-fed into the installation, e.g. the blast furnace.

It is a particular advantage that the plasma reactor may operate entirely using electricity, which may be produced eco-friendly, e.g. via solar power or wind power. The present invention presents several crucial advantages compared to the traditional techniques used in e.g. blast furnace operation:
Depending on the blast furnace and plasma reactor capacity, complete, or nearly complete reduction of the CO2 can be achieved. This means that it is possible to reduce the CO2 emissions from iron production by using only electrical energy. This is mainly due to the recycling of the stream, allowing multiple passes through the plasma zone of the CO2-comprising stream. The inventors have seen that at optimal conditions, a single pass of a CO2-comprising input stream allows to convert about 10% to 15% of the CO2 present in the stream into CO. This is not enough to allow the output stream to be re-used. Note hereby that extracting the CO2 or the CO from an output stream wherein only 10% to 15% of the CO2 is converted to CO, is highly inefficient. In the present invention, the conversion rate of CO2 to CO can be increased even up to 50% and more of the CO2 present in the initial input stream, making extraction of the CO2 or the CO in the final output stream much more efficient or, in some cases, even unnecessary.
A closed loop is created for the CO2 and CO. This means that conventional production of CO through gasification of coal (C+O2->2CO) is no longer necessary. This is a temperature-intensive process, which, if avoided will further contribute to the CO2 foot print reduction.
The plasma reactor depends on electrical energy only and does not need additional catalysts for the CO2→CO+O reaction. Possibly, and preferably only if necessary, catalysts may be used in a CO/O2 separation stage and/or a CO/CO2 separation stage. Note, however, that extraction of CO or separation of CO from e.g. oxygen may not be necessary.
The plasma reactor operates at high temperature, where the peak temperature of the gas can reach 3000K. This means that additional pre-heating of the recovered CO gas for usage in e.g. the blast furnace, is no longer needed, which allows avoiding another energy-intensive process.
No major re-structure of the blast furnace installation is needed. The present invention allows to be implemented as an upgrade to existing installations.

### OVERVIEW OF THE FIGURES

FIG. 1 illustrates an iron production method and system according to the present invention.

FIG. 2 illustrates a plasma reactor which can be used in embodiments of the present invention.

FIGS. 3 to 5 illustrate a method and system for producing CO according to embodiments of the present invention.

### DETAILED DESCRIPTION OF THE INVENTION

The present invention will now be discussed in more detail, with reference to the figures.

In a first aspect, the present invention thereto relates to a method for producing carbon monoxide (CO), comprising the steps of:
providing a gaseous initial input stream comprising carbon dioxide (CO2) to a plasma zone;
at least partially converting said CO2 to CO by:
(a) igniting a plasma in the plasma zone;
(b) extracting an output stream from the plasma zone, said output stream comprising less CO2 than said first stream, and
recycling said output stream as a gaseous input stream to said plasma zone and further converting CO2 to CO by performing steps (a) and (b), thereby obtaining a final output stream comprising more CO and less CO2 than the initial input stream.

The present invention also relates to a system for producing carbon monoxide, comprising:
a plasma reactor comprising a reactor chamber with a plasma zone, the plasma reactor being configured to ignite a plasma in the plasma zone, the plasma reactor further comprising a plasma inlet for a gaseous input stream and a plasma outlet for a gaseous output stream;
a CO2 input system configured to provide a gaseous initial input stream comprising CO2 to the plasma inlet of the plasma reactor;
an extraction system configured to extract a final output stream from the plasma outlet of the plasma reactor;
a recycling system configured to extract an output stream from the plasma zone and recycle said output stream as an input stream to the plasma zone.

In a second aspect, the present invention relates to an iron production method comprising the steps of:
produce iron from iron ore using CO, thereby releasing CO2;
capturing said CO2;
performing the method for producing CO as disclosed in this document, whereby the gaseous initial input stream comprises said captured CO2, thereby obtaining a final output stream comprising more CO and less CO2 than the initial input stream,
   whereby the CO in the final output stream is used to produce iron from iron ore.

The invention also relates to an iron production system comprising:
a blast furnace configured to produce iron from iron ore using CO, thereby also producing CO2, and
a carbon monoxide production system as disclosed in this document,
   whereby the blast furnace comprises a CO2 capturing system configured to capture the CO2 and to provide a gaseous initial input stream comprising said captured CO2 to the carbon monoxide production system, and whereby the carbon monoxide production system comprises a CO transfer system configured to provide a final output stream comprising more CO and less CO2 than the initial input stream to the blast furnace.

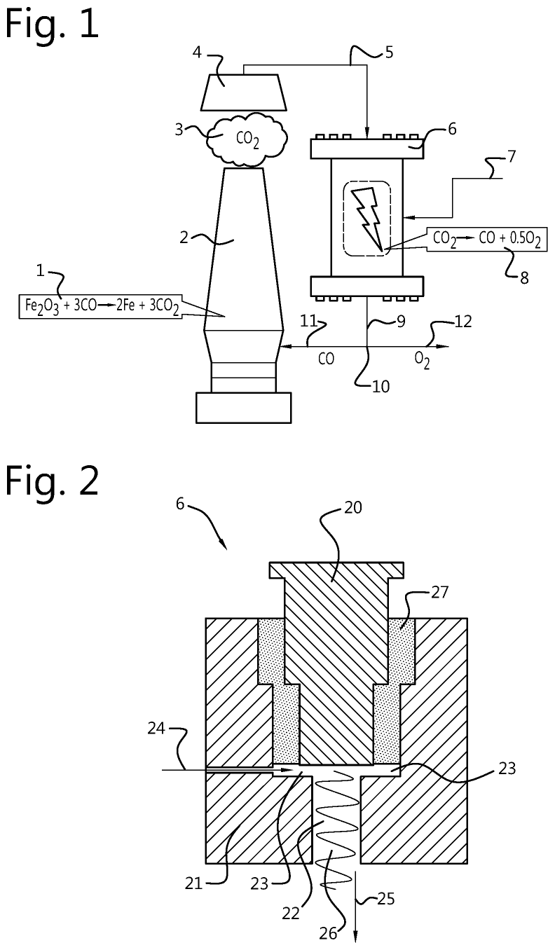

FIG. 1 illustrates an iron production method and system according to the present invention. Hereby, iron (Fe) is produced from iron ore (1) via the reduction of iron ore, e.g. in the form of Fe₂O₃, with CO in a blast furnace (2). The exhaust gasses comprise CO2, and can be captured by the CO2 capturing system (4). The CO2 comprising exhaust gas can be transported (5), e.g. via a exhaust gas transporting system which may comprise a set of pipes and/or pumps, to the plasma reactor (6). The exhaust gas from the blast furnace thus can serve integrally as initial input stream for the plasma reactor. Note hereby that a separation stage is not required here: if the exhaust gas comprises other components than CO2, such as nitrogen (N2) or oxygen (O2), these can also be present in the initial input stream. In the plasma reactor (6), which preferably operates on electrical energy (7), the CO2 is converted into CO and O2 (8). The resulting final output stream (9) can be separated by a separation system (10) into multiple separated stream, in this case a stream comprising CO (11), which can be reused in the blast furnace (2) and a stream comprising O2 (12), which O2 could also be re-used in other processes. Note that any other gasses present in the initial input stream, may also be present in the final output stream and thus in any of the separated streams.

In a preferred embodiment, the present invention relates to a method for producing carbon monoxide (CO), comprising the steps of:
providing a gaseous initial input stream comprising carbon dioxide (CO2) to a plasma zone; thereby producing a plasma output stream comprising CO2, CO and O2; and
converting said O2 in said plasma output stream to CO, CO2, or a mixture thereof; thereby producing a carbon donor output stream comprising CO and CO2.

In a further preferred embodiment, the present invention relates to a method for producing carbon monoxide (CO), comprising the steps of:
providing a gaseous initial input stream comprising carbon dioxide (CO2) to a plasma zone; thereby producing a plasma output stream comprising CO2, CO and O2,
reacting said plasma output stream comprising CO2, CO and O2 with carbon donor particles, thereby producing a plasma output stream comprising CO2 and CO.

In an embodiment, the reaction chamber comprises carbon donor particles and/or the method of the present invention comprises the step of adding carbon donor particles in the reaction chamber. This allows the oxygen radicals (O) in the plasma reaction CO₂→CO+O, to bind with the carbon of the carbon donor particles to form CO, thereby increasing the CO yield of the plasma process. As a result, the output stream will comprise less oxygen (O2) and a separation stage for separating the O2 from the final output stream may not be necessary.

In an embodiment, the carbon donor particles are added to the gaseous initial input stream. In another embodiment, the carbon donor particles are supplied to the plasma reactor by a separate inlet. In another embodiment, carbon donor particles are supplied to the plasma reactor in the plasma afterglow section of the plasma reactor. In another embodiment, carbon donor particles are provided subsequent to the plasma reactor. Preferably, carbon donor particles are supplied to the plasma reactor in the plasma afterglow section of the plasma reactor or immediately subsequent to the plasma reactor. The presence of reactive oxygen radical species and high temperatures are beneficial for rapid reaction to CO. By providing the carbon donor particles in the plasma afterglow, but not the plasma itself, saves energy as well as operational difficulties related to including carbon particles in the plasma phase.

In a preferred embodiment, the present invention relates to a method for producing carbon monoxide (CO), comprising the steps of:
providing a gaseous initial input stream comprising carbon dioxide (CO2) to a plasma zone; thereby producing a plasma output stream comprising CO2, CO and O2,
reacting said plasma output stream comprising CO2, CO and O2 with carbon donor particles, thereby producing a plasma output stream comprising CO2 and CO.

In a preferred embodiment, the particles are carbon particles in the form of a fine powder. These can be preferably supplied through an additional inlet with a carrier gas, such as air, or together with the main CO2 supply. The methods will most likely differ, as one will aid conversion in the post-plasma region (additional inlet), and the other will influence the plasma chemistry in the discharge itself. For instance, carbon particles in the plasma may facilitate faster CO formation, but, on the other hand, consume molecular oxygen (O), which normally contributes to the CO2 splitting process (neutral impacts). Carbon particles preferably have sizes with an average radii of between 0.05 and 0.5 mm. In a preferred embodiment, the carbon donor particles are in a fluidized state. In still another embodiment, a down flow of carbon-donor particles is created, preferably under the influence of gravity, while the down flow of carbon-donor particles is exposed to O radicals, preferably in counter-flow to the down flow.

In a preferred embodiment, the carbon-donor particles are positioned in a fixed bed. The fixed carbon bed can preferably be optimized using fluid dynamics and plasma model simulations, and the main focus can be at increasing the residence time inside the carbon bed, and achieving optimum reaction temperature (preferably at least 1500K). Furthermore, the carbon particles size and shape, and the overall carbon volume can preferably be optimized. Streaming CO2 through a carbon (coal) filter can already produce the main valuable chemical-CO, given that the reaction temperature is right. The Boudouard reaction needs at least 1500K in order to activate. In practice, this is achieved through heating of the carbon bed (though gas burning or electrical heaters). However, the plasma jet generator of the present invention has the advantage that it heats up the gas already-typically to even more than 3000K can be measured inside the plasma discharge. Plasma discharges are a very efficient way of warming up a gas, as they do not rely on additional convective heating elements. Furthermore, the gas in the reactor is already converted to some extent. The plasma conditions further create even more radicals, CO radicals and O radicals, which are highly reactive thereby increase efficiency.

Converting oxygen radicals and/or O2 to CO and/or CO2 is particularly advantageous to produce CO as well as use of said CO in a blast furnace. Conversion of O2 in a gas stream comprising O2/CO/CO2 prevents the energy intensive separation of oxygen while increasing the CO yields per pass. Furthermore, presence of carbon particles in the presence of high temperature conditions in or subsequent of the plasma reactor allow for CO2 and carbon to CO conversion through the reverse Boudouard reaction; further increasing the CO yield.

In a preferred embodiment, the present invention relates to a method for producing carbon monoxide (CO), comprising the steps of:
providing a gaseous initial input stream comprising carbon dioxide (CO2) to a plasma zone; thereby producing a plasma output stream comprising CO2, CO and O2,
reacting said plasma output stream comprising CO2, CO and O2 with carbon donor particles, thereby producing a plasma output stream comprising CO2 and CO,
separating said CO and CO2; thereby arriving at a CO-rich separator outlet and a CO2-rich separator outlet.

Advantageously, the removal of (most) oxygen from the plasma stream by fixation with carbon donor particles allows the separation of a predominantly binary rather than tertiary system. This allows for far easier and cheaper separation. In a further preferred embodiment, CO and CO2 are separated with cryogenic distillation, cryogenic flash or pressure-swing absorption (PSA). More preferably, CO and CO2 are separated with cryogenic flash. Advantageously, a single stage vapor/liquid separation method is considerably simpler, requires smaller, less technologically advanced equipment as well as lower energy requirements than cryogenic distillation. The inventors surprisingly found cryogenic distillation is sufficient to purify the CO-rich separator outlet to 99 wt. % CO. For purities over 99.99%, cryogenic distillation is likely preferred. For blast furnace applications this additional purity does not weigh up against the additional energy requirements.

In a further preferred embodiment, CO and CO2 are separated with a cryogenic flash or cryogenic distillation, more preferably a cryogenic flash. In preferred embodiment, the cryogenic flash or distillation operates at a temperature of at most −100° C., more preferably at most −110° C., more preferably at most −120° C., more preferably at most −130° C., more preferably at most −140° C. In a preferred embodiment, the cryogenic flash operates at a temperature of at least-180° C., more preferably at least −170° C., more preferably at least −160° C., more preferably at least −150° C. In preferred embodiment, the cryogenic flash or distillation operates at a pressure of at least 10 bar, more preferably at least 20 bar, more preferably at least 24 bar, more preferably at least 25 bar, most preferably about 26 bar. In preferred embodiment, the cryogenic flash or distillation operates at a pressure of at most 50 bar, more preferably at most 40 bar, more preferably at most 30 bar. The operating temperature and pressure of a distillation tower is a range; and the entirety of the range preferably falls within these specified ranges. In a preferred embodiment, the cryogenic distillation has at most 80 trays, more preferably at most 60 trays, more preferably at most 50 trays, more preferably at most 40 trays, more preferably at most 30 trays, more preferably at most 20 trays, more preferably at most 15 trays, more preferably at most 10 trays, more preferably at most 9 trays, more preferably at most 8 trays, more preferably at most 7 trays, more preferably at most 6 trays, more preferably at most 5 trays, more preferably at most 4 trays, more preferably at most 3 trays, more preferably at most 2 trays, more preferably at most 1 tray. A cryogenic distillation with only 1 tray is considered a cryogenic flash herein. The applicant surprisingly found that CO2 can be extracted, and assuming no further constituents, high purity CO can be obtained with a limited number of trays. Limiting the number of trays is then advantageous to reduce both complexity of installation as well as operating energy requirements.

In a preferred embodiment, the present invention relates to a method for producing carbon monoxide (CO), comprising the steps of:
providing a gaseous initial input stream comprising carbon dioxide (CO2) to a plasma zone; thereby producing a plasma output stream comprising CO2, CO and O2,
reacting said plasma output stream comprising CO2, CO and O2 with a carbon donor, said carbon donor comprising C, thereby producing a plasma output stream comprising CO2 and CO,
separating said CO and CO2; thereby arriving at a CO-rich separator outlet and a CO2-rich separator outlet; and
recycling said CO2-rich separator outlet to said gaseous initial input stream comprising carbon dioxide (CO2)

Inventors have surprisingly found the following method to be energetically highly favorable for the production of a CO-rich stream from a gaseous inlet comprising CO2. Plasma conversion allows for energetically efficient dissociation of CO2. Carbon donor particles scavenge O2 as well as oxygen radicals and promote reverse Boudouard reaction. This provides two benefits: greatly increasing the CO yield as well as removing the need for oxygen separation. CO and CO2 can then be separated to high purities. Purity of the CO-rich stream of at least 90%, up to 99% can be obtained without the need cryogenic distillation with large number of trays or subsequent purification processes. The CO2 rich stream can be trivially recycled. The CO-rich stream can advantageously be used in the reduction of iron ore.

In a preferred embodiment, the system for producing carbon monoxide further comprises:
a carbon donor system.

In an embodiment, said carbon donor system is configured to produce a down flow of carbon-donor particles, preferably under the influence of gravity, while the down flow of carbon-donor particles is exposed to O radicals, preferably in counter-flow to the down flow. In a preferred embodiment, the carbon-donor particles are positioned in a fixed bed.

The plasma reactor, and preferably the one or more reactor chambers thereof, can preferably be equipped with a swappable catalyst bed tray. In tris tray, various solids and liquids can preferably be added to the process, in order to enhance the conversion. One preferred example is coal, which upon heating by the plasma will improve the CO yield by the reverse Bouduard reaction. The catalyst tray can be fixed, or on continuous supply chain, i.e. a rotating belt or a feed screw. The catalyst bed can preferably be adjustable in position, i.e. up and down, in order to provide optimal distance to the plasma afterglow. Multiple stacked trays may also be preferred. A rail insert can be provided in the plasma reactor, and preferably the one or more reactor chambers thereof, to hold the catalyst tray.

In an embodiment of the invention, the plasma reactor comprises a set of electrodes (or waveguides, coils and contacts where applicable) in and/or around the plasma zone, the electrodes configured to ignite a plasma using any or any combination of the following:
Microwave (MW) excitation;
Radiofrequent (RF) discharge;
Dielectric Barrier Discharge (DBD);
Capacitively Coupled Discharge (CCD);
Inductively Coupled Discharge (ICD);
DC or AC Arc discharge;
Gliding Arc (GA) discharge;
Glow Discharge,
   or any equivalents thereof.

In an embodiment, the plasma reactor comprises a single reactor chamber. However, in other embodiments, the plasma reactor comprises two or more reactor chambers, each reactor chamber comprising a plasma zone. Hereby, the reactor chambers may be positioned in series and/or in parallel. The number of reactors may be any of 2, 3, 4, 5, 6, 7, 8, 9, 10 or more.

In an embodiment, the reactor chamber is made of steel, copper, aluminium, ceramics, plastic, or any combination thereof. Alternatively or additionally, the plasma reactor may be made of recycled materials.

In an embodiment, the plasma reactor comprises a DC or an AC electric power source. The power range of the plasma reactor may range between 1 and 1,000,000 kW.

In a preferred embodiment, the system for producing CO comprises multiple plasma reactors which are arranged in series and/or in parallel with respect to the initial input stream and the final output stream. Preferably, the multiple reactors are arranged in parallel. This allows upscaling of the system to large volumes of CO2 comprising streams. Hereby, the multiple plasma reactors may be arranged in a matrix form, and the initial input stream may be divided over the parallel-arranged reactors using a manifold and/or a set of division valves. Preferably the system comprises N plasma reactors, wherein N is between 2 and 10000, preferably between 10 and 5000, such as 2, 3, 4, 5, 6, 7, 8, 9, 10, 15, 20, 30, 50, 70, 100, 200, 300, 500, 700, 1000, 1500, 2000, 3000, 5000, 7000 or 10000.

Hereby, the system for producing CO may comprise a recycling system configured to receive the output streams of multiple plasma reactors and to recycle the combined output stream as an input stream for the multiple plasma reactors.

Alternatively, or additionally, the system for producing CO may comprise multiple recycling systems, each of which configured to receive the output stream of one plasma reactor or of a subset of the multiple plasma reactors and to recycle the output stream as an input stream for the one plasma reactor or the subset of the multiple plasma reactors.

In a preferred embodiment, the recycling system comprises one or more pumps and/or fans configured for pumping the output stream of a plasma reactor to an input of a different and/or the same plasma reactor. If such a pump is used, this pump may be of any suitable type, including centrifugal, rotary, positive displacement, diaphragm, gear and others.

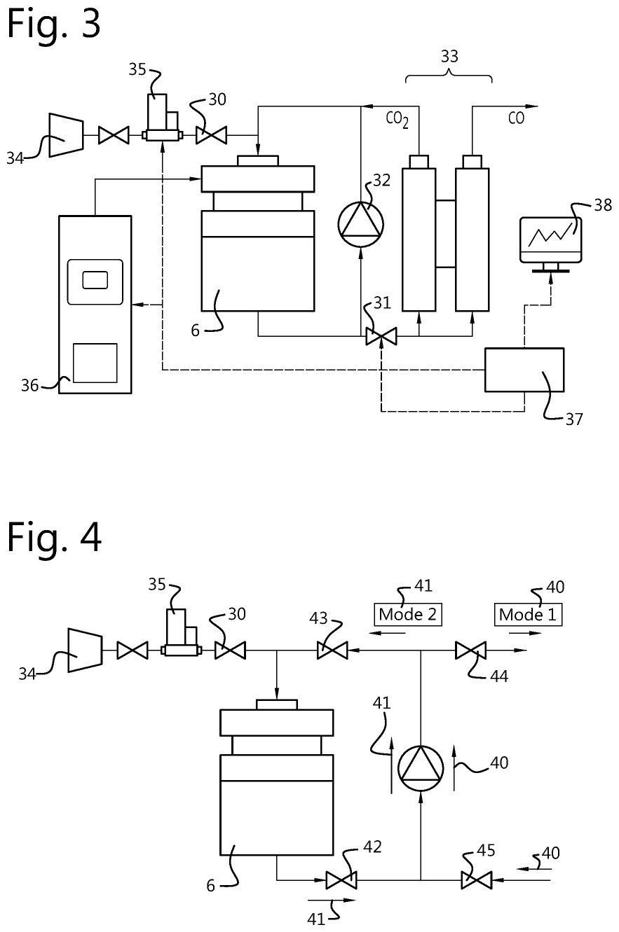

FIG. 2 illustrates a cross section of a cylindrical plasma reactor (6) which can be used in embodiments of the systems and methods of the present invention. The plasma reactor (6) comprises a cathode electrode (20) and an anode electrode (21) separated by an insulator (27). Preferably the cathode can be put on a high voltage and the anode can be grounded in order to ignite a plasma, e.g. using a plasma discharge. The plasma reactor (20) comprises:
an essentially cylindrical reaction chamber (22) which comprises a plasma zone (23) in between the electrodes (20, 21) wherein a plasma can be ignited;
a plasma inlet (24) for receiving an input stream comprising CO2, and
a plasma outlet (25) for evacuating an output stream wherein at least a portion of the CO2 of the input stream has been converted to CO.

The plasma zone (23) may preferably comprise an ignition gap, preferably a cylindrical ignition gap, between the electrodes of between 1 mm and 20 mm, preferably about 2 mm.

Preferably the plasma inlet (24) is positioned eccentric and/or tangential with respect to the reaction chamber, allowing formation of a vortex in the plasma and in the plasma afterglow.

Note that the plasma is ignited in the plasma zone, but that the conversion of the CO2 to CO may occur in the plasma zone and/or further downstream in the reaction chamber, e.g. in the plasma afterglow. Note that the plasma reactor (6) comprises a stabiliser for stabilizing a vortex (26) in the plasma and in the plasma afterglow, the stabiliser comprising a set of plasma reactor walls shaped to stabilize the vortex (26).

In an embodiment, the method for producing CO of the present invention comprises the step of separating the final output stream in two or more separated streams. Preferably hereby, the separating step comprises extraction of CO2 and/or extraction of oxygen (O2) from the final output stream. Preferably, the separating step makes use of any or any combination of:
membrane separation,
catalyst separation,
co-reactant separation,
a pressure-swing adsorption (PSA), and/or
a cryogenic distillation.

In an embodiment, the extraction system of the system for producing carbon monoxide comprises a separator for separating the final output stream in two or more separated streams, the separator being configured to extract CO2 and/or O2 from the final output stream. Preferably, the separator comprises any or any combination of:
a separation membrane, preferably a Ba_{0.5}Sr_{0.5}Co_{0.8}Fe_{0.2}O_{3-δ} (BSCF) membrane,
a separation catalyst,
a co-reactant,
a pressure-swing adsorption (PSA) separator, and/or
a cryogenic distillatory.

In a preferred embodiment, the system for producing carbon further comprises:
a carbon donor system, preferably said carbon donor system is located in said reactor chamber or downstream of said plasma reactor; and
a separator for separating the output stream of said carbon donor system; the separator being configured to extract CO2.

In a particular preferred embodiment, the system for producing carbon further comprises:
a carbon donor system, preferably said carbon donor system is located in said reactor chamber or downstream of said plasma reactor; and
a separator for separating the output stream of said carbon donor system;
the separator being configured to extract CO2, wherein said separator is a cryogenic flash.

The inventors have found that this combination of features removes the need to extract O2; drastically reducing the energy requirements and complexity of separator. In a preferred embodiment, the separator is a cryogenic flash. In a further preferred embodiment,

In a particular preferred embodiment, the system for producing carbon comprises:
a plasma reactor comprising a reactor chamber with a plasma zone, the plasma reactor being configured to ignite a plasma in the plasma zone, the plasma reactor further comprising a plasma inlet for a gaseous input stream and a plasma outlet for a gaseous output stream;
a CO2 input system configured to provide a gaseous initial input stream comprising CO2 to the plasma inlet of the plasma reactor;
a carbon donor system, said carbon donor system configured to provide carbon donor particles, preferably said carbon donor system provides said carbon donor particles to said reactor chamber or downstream of said reactor chamber;
a separator, said separator located downstream of said plasma reactor and carbon donor system, said separator configured to extract CO2 thereby producing a CO-rich separator output and a CO2-rich separator output.

Preferably said separator is chosen from: cryogenic flash, cryogenic distillation or a combination thereof. More preferably said separator is a cryogenic flash. In a further preferred embodiment, said CO2-rich separator output is fluidly connected to said CO2 input system; thereby recycling said CO2-rich separator output.

In a particular preferred embodiment, the system for producing carbon comprises:
a plasma reactor comprising a reactor chamber with a plasma zone, the plasma reactor being configured to ignite a plasma in the plasma zone, the plasma reactor further comprising a plasma inlet for a gaseous input stream and a plasma outlet for a gaseous output stream;
a CO2 input system configured to provide a gaseous initial input stream comprising CO2 to the plasma inlet of the plasma reactor;
a carbon donor system, said carbon donor system configured to provide carbon donor particles, preferably said carbon donor system provides said carbon donor particles to said reactor chamber or downstream of said reactor chamber;
a separator, said separator located downstream of said plasma reactor and carbon donor system, said separator configured to extract CO2 thereby producing a CO-rich separator output and a CO2-rich separator output;
wherein said CO2-rich separator output is fluidly connected to said CO2 input system.

Preferably, the plasma reactor comprises one or more catalyst bed trays as previously described, whereby the trays can preferably be provided with gas separation membranes such as BSCF hollow fibers, which are used for O2 scavenging.

In an embodiment, the recycling system of the system of the present invention comprises a set of recirculation blowers and/or recirculation pumps configured to recycle the output stream as an input stream to the plasma zone.

In an embodiment, the plasma is stabilized, preferably by using any or any combination of:
flow-based stabilisation methods such as by inducing a vortex, a reverse vortex and/or plasma recirculation;
wall-based stabilisation;
magnet stabilisation, which can be permanent and/or inductive stabilisation.

Accordingly, the plasma reactor of the system according to the present invention preferably comprises plasma stabilisation means, preferably any or any combination of:
flow-controlling means such as a vortex generator, a reverse-vortex generator and/or a plasma recirculatory;
a set of plasma reactor walls configured to stabilise the plasma in the plasma zone;
a magnet, such as a permanent and/or an inductive magnet.

The method and system for producing CO of the present invention can preferably be used to convert CO2 in an exhaust gas of a blast furnace to CO. Preferably the blast furnace uses said CO to produce iron from iron ore. Hereby, the complete process of producing iron from iron ore can be performed with reduced CO2 exhaust to the environment, preferably even without CO2 exhaust to the environment. Reduction of iron ore to iron requires energy, and the energy required to reduce the iron ore to iron can be obtained from electrical power, which can also be obtained with reduced or even without CO2 exhaust. The energy for the iron ore to iron reduction process comes from the plasma process wherein CO2 is converted to CO at high temperature.

The system for producing CO needs to be able to pass the CO2 comprising gas multiple times through the one or more plasma reactors, in order to achieve optimal conversion. A single pass may typically convert 10-15% of the CO2 gas. Passing through (recirculating) the gas 5 times yields about 50% CO₂ conversion. Flow rates may preferably be between 10 and 100 L/min per plasma reactor.

In an embodiment of the invention, the system for producing carbon monoxide comprises one or more inlet valves upstream of the plasma inlet and whereby the extraction system comprises one or more outlet valves downstream of the plasma outlet, whereby the one or more inlet valves are configured to:
in a first stage, fluidically connect the reaction chamber of the plasma reactor with a supply of a gaseous initial input stream comprising CO2, thereby allowing the gaseous initial input stream to enter the plasma zone of the reaction chamber;
in a second stage, fluidically close off the reaction chamber from said supply of the gaseous initial input stream comprising CO2 and fluidically connect the reaction chamber of the plasma reactor with the output stream from the plasma zone, thereby allowing the output stream to be recirculated as an input stream to the plasma zone, and
in a third stage, fluidically connect the reaction chamber of the plasma reactor with a supply of a gaseous initial input stream comprising CO2,
   and whereby the one or more output valves are configured to:
in the first stage and in the second stage, fluidically close off the reaction chamber of the plasma reactor from an extraction pathway of the extraction system, and
in the third stage, fluidically connect the reaction chamber of the plasma reactor to the extraction pathway of the extraction system, thereby allowing the final output stream to be extracted from the reaction chamber,
   and whereby the recycling system preferably comprises a flow actuator, preferably a pump, which is configured to:
in the second stage, recycle the output stream from the plasma outlet to the plasma inlet for use as a gaseous input stream to the plasma zone, and
in the first stage and in the third stage, not recycle the output stream from the plasma outlet to the plasma inlet for use as a gaseous input stream to the plasma zone.

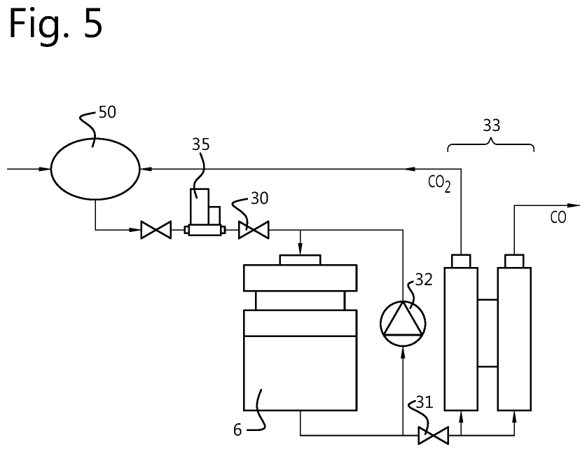

This embodiment is better illustrated in FIGS. 3 and 4.

During stage 1, valve 1 (30) is open and the system fills up with initial input gas from an initial gas stream supply (34). During this first stage, 10% of the CO2 in the gas can already be converted. Once the system is filled up with gas (1 cycle), valve 1 (30) closes, valve 2 (31) closes, and the pump (32) starts working. After 4 re-cycles, the conversion of CO2 reaches about 50%, upon which valve 2 (31) opens, and subsequently the pump (32) shuts off and valve 1 (30) opens to flush the system with initial input gas again. A separation stage (33) can preferably be included in the loop and feedback of excess CO2 that is not converted may be implemented. In this way, the system will operate in a “pulsed” regime. However, due to the small internal volume of the individual plasma reactors, this process will result in a very low residence time (of the order of 100 ms). A full re-circulation sequence takes between 0.1 and 10 seconds, preferably about 0.5 s. This results in a semi-continuous operation. Furthermore, when using multiple plasma reactors, the first, second and third stages may be shifted for different plasma reactors, such that the initial input stream may continuously be divided over a subset of the plasma reactors which are at any time in the first stage.

An example of the complete cycle can be summarized in the table below:

| | | | | | CO2 |
|---|---|---|---|---|---|
| Cycle step | MFC | Valve 1 | Valve 2 | Pump | Conversion |
| 1 | Open | Open | Closed | Off | 0 |
| (stage 1) | | | | | |
| 2 | Closed | Closed | Closed | On | 10% |
| (stage 2) | | | | | |
| 3 | Closed | Closed | Closed | On | 20% |
| (stage 2) | | | | | |
| 4 | Closed | Closed | Closed | On | 30% |
| (stage 2) | | | | | |
| 5 | Closed | Closed | Closed | On | 40% |
| (stage 2) | | | | | |
| 6 | Closed | Closed | Closed | On | 50% |
| (stage 2) | | | | | |
| 7 | Open | Open | Open | Off | 50% |
| (stage 3) | | | | | |

Each step of the cycle may preferably take between 50 and 500 ms, preferably about 100 ms.

The valves may preferably be controlled with electronic actuators connected to a computer board.

Depending on the operating conditions and total reactor volume, the recirculation pump may not be able to spin up fast enough in order to match the recirculation timing. In an embodiment, the recycling system, and preferably one or more pumps thereof, is configured to operate continuously, at full or reduced power, i.e. without startup-cycles. Instead of stopping the pumps, the one or more pumps are configured to operate in open air, and are configured to recycle an output gas stream by using a set of valves when required, e.g. in the recirculation stage, i.e. stage 2 in the embodiment presented above. See FIG. 4 for illustration of this embodiment. In FIG. 4, mode 1 (40) is designated as open-air operation, and mode 2 (41) is designated as recirculation. In mode 1, valves (42) and (43) are closed and valves (44) and (45) are open, while in mode 2, valves (42) and (43) are open and valves (44) and (45) are closed.

In embodiments, recycling may be obtained by pressure forces, pressure gradients and/or buoyance forces. In such embodiments, the recycling system may not comprise a pump. In embodiments, the valves described in 3, 4 and 5 may be fully open at all times. In such configurations, the gas flow may recirculate naturally, driven by pressure and buoyance forces.

In embodiments, re-circulation of an output stream as an input stream may be realized by by-pass piping and/or pumps, but may also be realized without by-pass piping and/or pumps. A passive system may preferably utilize an internal flap or a duct, re-directing the output stream partially, or completely back to the inlet of the reactor. Alternatively, or additionally, in an active system, a moving flap or a propeller may be installed, facilitating re-directing the output stream partially, or completely back to the inlet of the reactor. In certain embodiment, natural internal re-circulation of the gas in the reactor may occur. One preferred embodiment is to use a classical gliding arc suspended in an enclosed vessel of any given shape. Preferably, hereby, utilizing a central axial flow and an off-center outlet may facilitate internal recirculation. Additionally, internal recirculation is possible in vortex and reverse-vortex flow reactors.

In an embodiment, rotating, vibrating or displacing the plasma reactor, or at least a portion thereof, preferably a portion comprising the plasma zone, may be utilized to obtain recycling of the output stream as an input stream.

Note that in an embodiment, the system comprises any or any combination of the following:
an initial gas stream supply (34);
a main flow controller (MFC) (35) for arranging the flow and flow rates of the initial input gas stream;
an electrical power supply (36) for providing the plasma reactor (6) and/or the recycling pump (32) with electrical energy;
electronics (37) configured for controlling, regulating and/or monitoring (38) the process and process parameters.

In an embodiment, the plasma reactor can be devised in a tubular shape, but may also be devised in a rectangular, conical, planar or spherical shapes, and/or any combination thereof and of a tubular shape.

In the present invention, preferably at least 50% of the CO2 in the initial gaseous input stream is converted to CO. This means that a portion of the CO2 in the initial input stream may still be present in the final output stream. Therefore, preferably the method of the present invention comprises the step of separating CO2 from the output stream and/or the final output stream. Preferably, the separated CO2 is fed back into the plasma reactor as an initial input stream. This creates a secondary CO2 stream, in addition to the main input, e.g. coming directly from a blast furnace. Preferably, therefor, the system comprises an input mixer and/or a buffer stage configured to mix and/or store the main CO2 input stream and/or the secondary CO2 input stream. The buffer may comprise an expansion chamber and/or a gas delivery pipe capable of withstanding high pressure. The buffer (50) is illustrated in FIG. 5.

In an embodiment of the iron production method and system of the invention, the plasma reactor may be attached directly to the blast furnace body. In other embodiments, the initial input stream comprising CO2 is transported to the plasma reactor by pipes or by pressurised containers. In an embodiment of the invention, the exhaust gas of the blast furnace may be liquefied and transported to the plasma reactor. Hereby the liquefied exhaust gas may preferably be evaporated in order to be used as initial input stream.

In an embodiment, co-reactants are added to the input stream in the reaction chamber. Preferably the co-reactants comprise any or any mixture of: water vapour, carbon and/or sulphur.

In an embodiment, the initial input stream comprises essentially pure CO₂ gas, e.g. comprising at least 98 vol. % of CO2. In other embodiments, the initial input stream is a mixture of components, said mixture comprising CO2 and any or any combination of CO, hydrogen (H2), nitrogen (N2), oxygen (O2), Argon (Ar), methane (CH4), and/or water (H2O).

In an embodiment, the plasma reactor is configured to operate at a range of gas flow rates between 1 to 10,000,000 L/min.

In an embodiment, the plasma reactors are configured to operate at a pressure in the range of 1 atm to 100 atm.

In a preferred embodiment, recycling the output stream as an input stream comprises the step of cooling down the output stream, preferably by:
expanding the output stream, preferably into a vessel which is preferably volumetrically larger than the plasma reactor and/or the reactor chamber and/or
utilizing a heat exchanger, e.g. in the form of a radiator for radiating heat or transferring heat to another media.

In a preferred embodiment, the second aspect of the invention relates to an iron production method comprising the steps of:
producing iron from iron ore using CO, thereby releasing CO2 in a blast furnace;
capturing said CO2;
providing a gaseous initial input stream comprising carbon dioxide (CO2) to a plasma zone; thereby producing a plasma output stream comprising CO2, CO and O2;
reacting said plasma output stream comprising CO2, CO and O2 with a carbon donor, said carbon donor comprising C, thereby producing a plasma output stream comprising CO2 and CO;
separating said CO and CO2; thereby arriving at a CO-rich separator outlet and a CO2-rich separator outlet;
recycling said CO2-rich separator outlet to said gaseous initial input stream comprising carbon dioxide (CO2); and
recycling said CO-rich separator outlet to said blast furnace.

The invention also relates to an iron production system comprising:
a blast furnace configured to produce iron from iron ore using CO, thereby producing CO2, and
a plasma reactor comprising a reactor chamber with a plasma zone, the plasma reactor being configured to ignite a plasma in the plasma zone, the plasma reactor further comprising a plasma inlet for a gaseous input stream and a plasma outlet for a gaseous output stream;
a CO2 input system configured to provide a gaseous initial input stream comprising CO2 to the plasma inlet of the plasma reactor;
a carbon donor system, said carbon donor system configured to provide carbon donor particles, preferably said carbon donor system provides said carbon donor particles to said reactor chamber or downstream of said reactor chamber;
a separator, said separator located downstream of said plasma reactor and carbon donor system, said separator configured to extract CO2 thereby producing a CO-rich separator output and a CO2-rich separator output;
wherein said CO2-rich separator output is fluidly connected to said CO2 input system; and
wherein said CO-rich separator output is fluidly connected to said blast furnace.

This method and system have several major advantages:
The energy requirements are predominantly in the plasma reactor; allowing efficiency gains as well as electrification of the energy demand. In current processes, energy demand is predominantly from oxidating fossil carbon sources; making electrification difficult.
CO2 emissions are drastically to entirely reduced. CO2 is efficiently recycled and reused.
Carbon demand is drastically reduced. Most carbon comes from recycled CO2.
Regardless of previous point, adding a relatively small amount of carbon in the form of carbon donor particles reduces almost all free oxygen radicals and O2. This further reduces the energy requirements by removing the need for extraction or separation of free oxygen after plasma dissociation of CO2. This also simplifies the required separation equipment.

### EXAMPLES

The separation of a series of CO2/CO/O2 mixtures was modelled. The CO to O2 ratio was modelled starting from CO2 dissociation. 2 CO2 is thus converted to 2 CO and 1 O2 molecules. The ratio of CO2 to CO and O2 is determined by the single pass conversion of the plasma reactor. The selection criterium was a CO-rich stream with at least 99 wt. % CO and max. 0.2 wt. % O2. Oxygen is not desired for downstream use of the CO rich stream in blast furnace applications.

### Comparative Example 1

The applicant modelled a range of cryogenic flash setups over the full range of CO2/CO/O2 mixtures. The applicant did not find a single cryogenic flash able to meet these criteria. The CO-content in the CO-rich stream was limited due to the inability to effectively separate both O2 and CO2 from CO. Additional separation stages were required to obtain a CO-rich stream according to the spec of 99 wt. % CO; leading to increased energy requirements and additional complexity.

### Example 2

Cryogenic distillation of a series of CO2/CO/O2 mixtures was modelled. The distillation column is designed to have a distillate temperature of −142° C. and a bottom temperature of −132° C. The operating pressure is 26 bar and the column consists of 60 stages. Table 1 shows the results from this method at a feed rate of 10000 tonnes/year. We can see that the desired CO concentration between 99-100% is only reached at 10, 20 and 100% CO₂ conversion. It is clear that 100% CO2 conversion is currently not yet achievable. Conversion of 10 and 20% is achievable but higher conversion is clearly desired. It is furthermore noted that while high purity CO stream is obtained, the mass flow rate of this stream remains low. Reducing the purity of CO results in the oxygen content exceeding the 0.2% maximum.

TABLE 1
Separation of CO2/CO/O2 mixture with cryogenic distillation

| Feed composition | | | | |
|---|---|---|---|---|
| CO₂ | CO | O₂ | CO mass flow | CO - product |
| [wt %] | [wt %] | [wt %] | [t/y] | [wt %] |
| 90 | 6.36 | 3.64 | 243.24 | 99.91 |
| 80 | 12.73 | 7.27 | 576.11 | 99.62 |
| 0 | 63.64 | 36.36 | 1335.92 | 99.58 |

Examples 1 and 2 show the difficulty in separating the output of a CO2 dissociation process, i.e. a gas comprising CO2, CO and O2.

### Example 3

A fixed carbon particle bed was added downstream of the plasma reactor. The applicant found the addition of this carbon particle bed eliminated the oxygen content from the resulting gas stream almost completely (down to ppm range).

The location of the carbon particle bed was varied between very close to the plasma reaction zone, in the plasma afterglow region and a substantial distance between plasma reactor and carbon particle bed. In both cases, oxygen was almost fully eliminated. However, the CO to CO2 ratio varied. Higher CO content was found when the carbon particle bed was placed in the plasma afterglow zone.

Without being bound to theory, it is assumed that O2 and/or oxygen radicals quickly react with available carbon particles. Removal of O2 and oxygen radicals limits the combination with available CO to form CO2. Furthermore, available CO2 may react with carbon particles to form CO through the reverse Boudouard reaction, promoted at higher temperatures. It was thus found that the addition of a carbon donor increases CO yields; which may further be impacted by the location of said carbon particles.

### Example 4

Separation of CO2/CO gas streams was investigated over a wide range of CO2 to CO ratios. The applicant found that a cryogenic flash operated at −140° C. and at a pressure of 26 bar resulted in a 99.8% pure CO top stream for mixtures between 10 and 90% CO₂ for all feed rates. Table 2 shows the results that belong to the feed stream of 10,000 tonnes/year. Furthermore, high mass flow rates were obtained.

This shows that the CO and CO2 streams may be separated and recycled to blast furnace and plasma reactor respectively for a wide range of (single pass) plasma reactor conversion rates.

TABLE 2

Feed composition

| CO₂ | CO | CO mass flow rate | CO - product |
|---|---|---|---|
| [wt %] | [wt %] | [t/y] | [wt %] |
| 90 | 10 | 667.66 | 99.8 |
| 80 | 20 | 1706.87 | 99.8 |
| 70 | 30 | 2746.08 | 99.8 |
| 60 | 40 | 3785.29 | 99.8 |
| 50 | 50 | 4824.51 | 99.8 |
| 40 | 60 | 5863.72 | 99.8 |
| 30 | 70 | 6902.93 | 99.8 |
| 20 | 80 | 7942.14 | 99.8 |
| 10 | 90 | 8981.35 | 99.8 |

### Example 5

Pressure swing absorption of a series of CO2/CO/O2 mixtures was modelled, similar to those discussed in examples 1 and 2. Pressure swing absorption did not result in any streams with a CO purity of at least 90%.

### Example 6

Pressure swing absorption of a series of CO2/CO mixtures was modelled, similar to those discussed in examples 4. A result of 98.09% CO was achieved only with a 10% CO2/90% CO mixture. PSA thus only achieved high purity CO if very high reactor conversion can be obtained, even with the addition of a carbon donor.

1. A method for producing carbon monoxide (CO), comprising the steps of:
providing a gaseous initial input stream comprising carbon dioxide (CO2) to a plasma zone;
at least partially converting said CO2 to CO by:
(a) igniting a plasma in the plasma zone;
(b) extracting an output stream from the plasma zone, said output stream comprising less CO2 than said initial input stream, and
recycling said output stream as a gaseous input stream to said plasma zone and further converting CO2 to CO by performing steps (a) and (b),
thereby obtaining a final output stream comprising more CO and less CO2 than the initial input stream.

2. The method according to claim 1, comprising the steps of:
providing said gaseous initial input stream comprising carbon dioxide (CO2) to said plasma zone; thereby producing said output stream comprising CO2, CO and O2;
reacting said output stream comprising CO2, CO and O2 with a carbon donor, said carbon donor comprising C, thereby producing a plasma output stream comprising CO2 and CO;
separating said CO and CO2; thereby arriving at a CO-rich separator outlet and a CO2-rich separator outlet; and
recycling said CO2-rich separator outlet to said gaseous initial input stream comprising carbon dioxide (CO2).

3. The method according to claim 2, wherein the carbon donor is selected from the list of: charcoal, coal, cokes or a combination thereof, most preferably cokes.

4. The method according to claim 2, wherein said carbon donor comprises a fixed carbon bed or a fluidized carbon particle reactor.

5. The method according to claim 2, wherein said separator comprises cryogenic flash or cryogenic distillation.

6. The method according to claim 1, wherein recycling the output stream as an input stream comprises the step of cooling down the output stream by:
expanding the output stream; or
utilizing a heat exchanger; or
a combination thereof.

7. A system for producing carbon monoxide, comprising a:
a plasma reactor comprising a reactor chamber with a plasma zone, the plasma reactor being configured to ignite a plasma in the plasma zone, the plasma reactor further comprising a plasma inlet for a gaseous input stream and a plasma outlet for a gaseous output stream;
a CO2 input system configured to provide a gaseous initial input stream comprising CO2 to the plasma inlet of the plasma reactor;
an extraction system configured to extract a final output stream from the plasma outlet of the plasma reactor;
a recycling system configured to extract said gaseous output stream from the plasma zone and recycle said gaseous output stream as said gaseous input stream to the plasma zone.

8. The system according to claim 7, said system further comprising:
a carbon donor system, wherein said carbon donor system is configured to provide a carbon donor to said plasma reactor or downstream of said plasma reactor; and
a separator for separating the output stream, wherein said separator is downstream of said carbon donor system; the separator being configured to extract CO2.

9. The system according to claim 8, wherein said separator is chosen from a cryogenic flash or a cryogenic distillation tower.

10. The system according to claim 8, comprising multiple of the plasma reactors which are arranged in series and/or in parallel with respect to the gaseous initial input stream and the final output stream.

11. The system according to claim 8, further comprising one or more inlet valves upstream of the plasma inlet, whereby the extraction system comprises one or more outlet valves downstream of the plasma outlet, whereby the one or more inlet valves are configured to:
in a first stage, fluidically connect the reaction chamber of the plasma reactor with a supply of the gaseous initial input stream comprising CO2, thereby allowing the gaseous initial input stream to enter the plasma zone of the reaction chamber;
in a second stage, fluidically close off the reaction chamber from said supply of the gaseous initial input stream comprising CO2 and fluidically connect the reaction chamber of the plasma reactor with the output stream from the plasma zone, thereby allowing the output stream to be recirculated as a gaseous input stream to the plasma zone, and
in a third stage, fluidically connect the reaction chamber of the plasma reactor with the supply of the gaseous initial input stream comprising CO2,
and whereby the one or more output valves are configured to:
in the first stage and in the second stage, fluidically close off the reaction chamber of the plasma reactor from an extraction pathway of the extraction system, and
in the third stage, fluidically connect the reaction chamber of the plasma reactor to the extraction pathway of the extraction system, thereby allowing the final output stream to be extracted from the reaction chamber,
and whereby the recycling system comprises a flow actuator, which is configured to:
in the second stage, recycle the output stream from the plasma outlet to the plasma inlet for use as the gaseous input stream to the plasma zone, and
in the first stage and in the third stage, not recycle the output stream from the plasma outlet to the plasma inlet for use as the gaseous input stream to the plasma zone.

12. The system according to claim 8, wherein the plasma reactor uses a gliding arc suspended in an enclosed vessel.

13. The system according to claim 8, wherein the plasma reactor comprises a vortex flow reactor or a reverse-vortex flow reactor for obtaining internal recirculation.

14. An iron production method comprising the steps of:
produce iron from iron ore using CO, thereby releasing CO2 in a blast furnace;
capturing said CO2;
providing a gaseous initial input stream comprising carbon dioxide (CO2) to a plasma zone, thereby producing a plasma output stream comprising CO2, CO and O2;
reacting said plasma output stream comprising CO2, CO and O2 with a carbon donor, said carbon donor comprising C, thereby producing a plasma output stream comprising CO2 and CO;
separating said CO and CO2, thereby arriving at a CO-rich separator outlet and a CO2-rich separator outlet;
recycling said CO2-rich separator outlet to said gaseous initial input stream comprising carbon dioxide (CO2); and
recycling said CO-rich separator outlet to said blast furnace.

15. The system according to claim 8, further comprising:
a blast furnace configured to produce iron from iron ore using CO, thereby producing CO2,
wherein said CO-rich separator output is fluidly connected to said blast furnace, wherein said separator is located downstream of said plasma reactor and said separator is configured produce a CO-rich separator output and a CO2-rich separator output, and wherein said CO2-rich separator output is fluidly connected to said CO2 input system.

16. The method according to claim 3, wherein said carbon donor is cokes.

17. The method according to claim 6, wherein the expanding the output stream is into a vessel that is volumetrically larger than the plasma reactor and/or the reactor chamber.

18. The method according to claim 6, wherein said heat exchanger is a radiator for radiating heat or transferring heat to another media.

19. The system of claim 11, wherein the flow actuator is a pump.

20. The system of claim 12, wherein the gliding arc has a central axial flow and an off-center outlet to facilitate internal recirculation.
